(19) United States
(12) Patent Application Publication
(10) Pub. No.: US 2024/0266543 A1
(43) Pub. Date: Aug. 8, 2024

(54) CARBON MATERIAL, ELECTRODE INCLUDING CARBON MATERIAL, SECONDARY BATTERY, AND METHOD OF PRODUCING CARBON MATERIAL

(71) Applicant: Murata Manufacturing Co., Ltd., Nagaokakyo-Shi (JP)

(72) Inventor: Yuji KINTAKA, Nagaokakyo-Shi (JP)

(21) Appl. No.: 18/637,952

(22) Filed: Apr. 17, 2024

Related U.S. Application Data
(63) Continuation of application No. PCT/JP22/41099, filed on Oct. 27, 2022.

(30) Foreign Application Priority Data
Nov. 15, 2021 (JP) 2021-185788

(51) Int. Cl. H01M 4/62; H01M 4/13

(52) U.S. Cl. CPC H01M 4/625; H01M 4/13

(57) ABSTRACT

Provided are a carbon material, an electrode including the carbon material, a secondary battery, and a method of producing the carbon material. The carbon material includes fibrous carbon; a covering material that covers portions of the fibrous carbon such that the fibrous carbon has an exposed portion in which a part of the fibrous carbon is exposed from the covering material.

### CROSS REFERENCE TO RELATED APPLICATIONS

The present application is a continuation of International application No. PCT/JP2022/041099, filed Oct. 27, 2022, which claims priority to Japanese Patent Application No. 2021-185788, filed Nov. 15, 2021, the entire contents of each of which are incorporated herein by reference.

### TECHNICAL FIELD

The present disclosure relates to a carbon material, an electrode including a carbon material, a secondary battery, and a method of producing a carbon material.

### BACKGROUND ART

In recent years, a lithium sulfur secondary battery using a sulfur-based material as a positive electrode active material and lithium metal as a negative electrode active material has attracted attention. A theoretical storage capacitance of a sulfur electrode is about 1670 mAh/g, and it is known that the theoretical storage capacitance is about 10 times higher than LiCoO₂ (about 140 mAh/g) which is one example of a typical positive electrode active material of a lithium ion battery.

As an example of a lithium sulfur secondary battery, Patent Document 1 describes “a battery in which a positive electrode includes a current collector and a positive electrode active material, the current collector includes a sulfur-nitrogen co-doped layer and a plurality of entangled carbon nanotubes, the sulfur-nitrogen co-doped layer is coated on a surface of each carbon nanotube, and intersections of adjacent carbon nanotubes are bonded by a sulfur, nitrogen-codoped carbon layer” (see, for example, claim 5 of Patent Document 1).

Patent Document 2 describes “a sulfur-carbon composite comprising a high graphite carbon material and sulfur, wherein sulfur is encapsulated into a porous structure of a highly graphitic carbon material” (see, for example, claim 1 of Patent Document 2).
Patent Document 1: Japanese Patent Application Laid-Open No. 2020-31045
Patent Document 2: Japanese Patent No. 6726279

### SUMMARY OF THE DISCLOSURE

In a carbon material 100 of the positive electrode used in the conventional lithium sulfur secondary battery, as shown in FIG. 6, a surface of a fibrous carbon 110 such as carbon nanotubes is totally covered with a carbon material 120 (sulfur-nitrogen co-doped layer or highly graphitic carbon material), and the carbon material is meshed as a whole.

In the meshed carbon material 100, the number of voids H increases due to the mesh, and when the carbon material 100 is used for an electrode (positive electrode), an electrode density decreases due to the voids H. Therefore, not only a decrease in energy density due to an increase in electrode volume due to the void H but also a large amount of an electrolytic solution to be impregnated into the electrode is required, and thus there is a problem that the energy density of the battery decreases.

The present disclosure has been made in view of such a demand. That is, a main object of the present disclosure is to provide a carbon material capable of improving an energy density of a battery, an electrode including the carbon material, a secondary battery, and a method of producing the carbon material.

The inventor of the present application has attempted to solve the above-described problems by addressing the problems in a new direction rather than addressing the problems as an extension of the prior art. As a result, a solid-state battery that achieves the above main object has been disclosed.

A carbon material according to the present disclosure includes: fibrous carbon; and a covering material that covers portions of the fibrous carbon the fibrous carbon has an exposed portion in which a part of the fibrous carbon is exposed from the covering material.

An electrode according to the present disclosure includes the carbon material.

In a secondary battery according to the present disclosure, the electrode is a positive electrode. Furthermore, in the secondary battery according to the present disclosure, the electrode is a negative electrode.

A method of producing a carbon material according to the present disclosure includes: covering fibrous carbon with a covering material; and exposing a part of the fibrous carbon from the covering material.

According to the carbon material, the electrode including the carbon material, the secondary battery, and the method of producing the carbon material according to the present disclosure, an energy density of the battery can be improved.

### BRIEF EXPLANATION OF THE DRAWINGS

FIG. 1 is a schematic view of a carbon material of an embodiment according to the present disclosure.

FIG. 2A is an SEM photograph obtained by irradiating the carbon material of the embodiment according to the present disclosure with an electron beam at an acceleration voltage of 5 kV and imaging the carbon material at an observation magnification of 50,000 times.

FIG. 2B is an SEM photograph obtained by irradiating the carbon material of the embodiment according to the present disclosure with an electron beam at an acceleration voltage of 5 kV and imaging the carbon material at an observation magnification of 10,000 times.

FIG. 3 is an SEM photograph obtained by irradiating the carbon material of Comparative Example with an electron beam at an acceleration voltage of 5 kV and imaging the carbon material at an observation magnification of 10,000 times.

FIG. 4 is a graph showing an adsorption/desorption isotherm of a covering material of the embodiment according to the present disclosure.

FIG. 5 is a graph showing a pore distribution of the covering material of the embodiment according to the present disclosure.

FIG. 6 is a schematic view of a carbon material of a positive electrode used in a conventionally known lithium sulfur secondary battery.

### DETAILED DESCRIPTION OF THE PREFERRED EMBODIMENTS

Hereinafter, the “carbon material”, the “electrode” including the carbon material, the “secondary battery” including the electrode, and the “method of producing a carbon material” of the present disclosure will be described in detail. Although the description will be made with reference to the drawings as necessary, the illustrated contents are only schematically and exemplarily illustrated for the understanding of the present disclosure, and the appearance, the dimensional ratio, or the like may be different from the actual ones. The various numerical ranges mentioned in the present specification are intended to include the lower and upper numerical values themselves, unless otherwise stated. More specifically, for example, to take a numerical range such as 1 to 10 as an example, unless otherwise stated, the range can be construed as including not only the lower limit of “1” but also the upper limit of “10”.

### —Embodiment of Carbon Material—

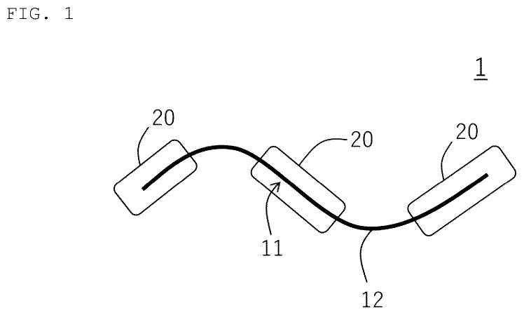

First, the “carbon material” according to an embodiment of the present disclosure will be described with reference to FIG. 1. The “carbon material” referred to in the present specification may be a material having conductivity, and the conductivity refers to a property that allows a current to substantially flow.

The carbon material of the present embodiment includes fibrous carbon 11, and a covering material 20 covering the fibrous carbon 11, and fibrous carbon 11 has an exposed portion 12 in which a part of the fibrous carbon 11 is exposed from the covering material 20 (see FIG. 1). Hereinafter, components included in the carbon material will be described in detail.

### <Fibrous Carbon>

The fibrous carbon 11 is intended to be carbon having a fiber-like shape (elongated shape such as a columnar shape), and preferably has conductivity. For example, carbon nanotubes or carbon nanofibers are preferable as an example of the fibrous carbon. The carbon nanotube is intended to be formed by rounding graphite in a cylindrical shape, the cylinder has a diameter of several nm to several tens nm, and, for example, single-walled carbon nanotubes (SWCNTs), multi-walled carbon nanotubes (MWCNTs) such as double-walled carbon nanotubes (DWCNTs), and the like can be used. The carbon nanofiber is intended to be a carbon-based fiber having a fiber diameter of several hundred nm or more and many branched structures, and for example, a vapor growth carbon fiber (VGCF (registered trademark)) or the like may be used.

### <Covering Material>

The covering material 20 covers the fibrous carbon 11. The covering material is preferably a material containing carbon. As a more preferable material, activated carbon may be used. When the covering material 20 is activated carbon, molecules and the like can be adsorbed to the activated carbon. As a preferable aspect of the covering material 20, the covering material may be porous in which a plurality of pores are formed. When the covering material 20 is porous, molecules and the like can be accommodated in the pores. That is, the term “porous” as used herein intends a material having a plurality of pores capable of accommodating molecules, and the term “activated carbon” as used herein intends a substance mainly composed of porous carbon that has been subjected to a chemical or physical treatment in order to increase adsorption efficiency.

### <Characteristic Element of Carbon Material>

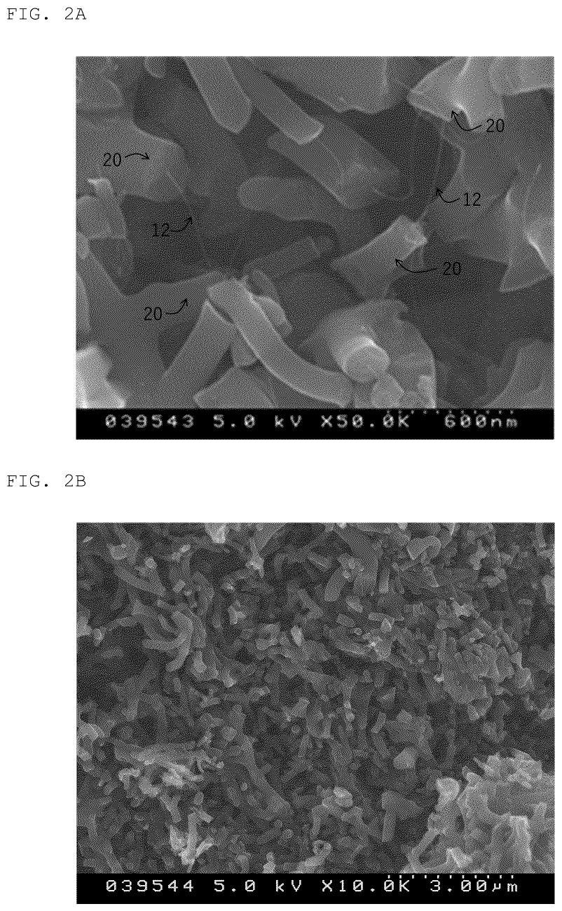

A carbon material 1 of the present disclosure has the exposed portion 12 in which a part of the fibrous carbon 11 is exposed from the covering material 20 (see FIGS. 1 and 2A). The term “exposed” as used herein intends a state in which the fibrous carbon 11 is exposed to the outside. With such a carbon material, in the exposed portion 12 which is a part of the fibrous carbon 11, the covering material 20 is not covered, and therefore the exposed portion 12 can be bent. The term “bent” as used herein intends bending with the exposed portion 12 as a starting point.

Although the exposed portion 12 may be formed at any position in the carbon material 1, the covering materials 20 are preferably provided on both sides of the exposed portion 12 from the viewpoint of reducing the number of voids due to bending of the carbon material 1. In other words, the exposed portion 12 is preferably formed at a position away from an end of the fibrous carbon 11.

More preferably, the exposed portion 12 may be bendable. In other words, the fibrous carbon 11 may have flexibility. Specifically, the fibrous carbon 11 may act to move flexibly by the exposed portion 12. According to such a configuration, since the carbon material 1 can be freely bent, the number of voids can be reduced, and the density can be increased.

—Other embodiments of carbon material—

As another embodiment of the carbon material 1, the covering material 20 is constructed as a support that supports the electrode active material. In other words, the electrode active material may be supported by the covering material 20 in the porous or activated carbon mode described above. The term “support” as used herein intends that the electrode active material is contained in the covering material 20 by a chemical bond or a physical bond. More specifically, it is intended that the electrode active material is encapsulated in a hole formed in the covering material 20. As described above, the covering material 20 acts as a support that supports the electrode active material, whereby the covering material can function as a battery electrode.

The electrode active material is preferably a sulfide. An example is sulfur. By using sulfur for the electrode active material, a battery having a large theoretical storage capacitance can be obtained. The content of sulfur in the covering material 20 is preferably 50% by weight to 65% by weight based on the entire carbon material. When sulfur is contained in such a numerical range, a battery having good energy density characteristics can be obtained.

### —Embodiment of Electrode Using Carbon Material—

Next, the “electrode using a carbon material” according to the embodiment of the present disclosure will be described. The electrode of the present embodiment includes the above-described carbon material. In addition, as an arbitrary configuration, an electrode material serving as a substrate of the electrode, a conductive auxiliary agent used for reducing resistance of the electrode, and/or a current collector for collecting current between the electrodes may be provided. In the following description, the electrode of the present embodiment will be described as the positive electrode; however, the “electrode using a carbon material” according to the embodiment of the present disclosure may be used for the negative electrode.

### <Electrode Material>

As an example of the electrode material as an arbitrary configuration, an aluminum foil may be used. That is, the above-described carbon material and/or conductive auxiliary agent may be provided on the aluminum foil, and the current may be optionally collected by the current collector.

### <Conductive Auxiliary Agent>

Examples of the conductive auxiliary agent as an arbitrary configuration include carbon materials such as graphite and carbon black. As carbon black, for example, acetylene black or ketjen black can be used. Alternatively, a material other than carbon materials may also be used, as long as the material has good electric conductivity. For example, a metallic material such as a Ni powder, a conductive polymeric material and the like can also be used. Examples of the binder contained in the electrode used as the positive electrode include fluorine-based resins such as polyvinylidene fluoride (PVdF) and polytetrafluoroethylene (PTFE) and polymeric resins such as a polyvinyl alcohol (PVA)-based resin and a styrene-butadiene copolymer rubber (SBR)-based resin. A conductive polymer may be used as the binder. As the conductive polymer, for example, substituted or unsubstituted polyaniline, polypyrrole and polythiophene, and a (co) polymer formed of one or two components selected therefrom may be used.

### <Current Collector>

The current collector as an arbitrary configuration is a member that contributes to collecting and supplying electrons generated in the active material due to the battery reaction. Such a current collector may be a metal member in a sheet form, and may have a porous or perforated form. For example, the current collector may be a metal foil, a punching metal, a net, an expanded metal, or the like. The positive electrode current collector used for the positive electrode preferably includes a metal foil containing at least one selected from a group consisting of aluminum, stainless steel, nickel, and the like, and may be, for example, an aluminum foil.

Although the electrode material, the conductive auxiliary agent, and/or the current collector have been described above as an arbitrary configuration in the electrode using the carbon material, the carbon material according to the present disclosure may act as the conductive auxiliary agent, the electrode material, and/or the current collector. That is, the material according to the present disclosure may also serve as a conductive aid, an electrode material, and/or a current collector.

As described above, in the electrode using the carbon material according to the present embodiment, the carbon material 1 includes the fibrous carbon 11, the covering material 20 covering the fibrous carbon 11, and the exposed portion 12 in which a part of the fibrous carbon 11 is exposed from the covering material 20. According to the electrode using the carbon material, since the exposed portion 12 in which a part of the fibrous carbon 11 is exposed from the covering material 20 is provided, the exposed portion 12 can be bent to reduce the number of voids in the electrode, and the energy density of the battery can be improved.

### —Embodiment of Secondary Battery—

Next, a “secondary battery including an electrode including a carbon material as a positive electrode” according to the embodiment of the present disclosure will be described. A preferred secondary battery may be a secondary battery using an alkali metal or an alkaline earth metal. More specifically, the battery may be a lithium sulfur battery, a magnesium sulfur battery, or a sodium sulfur battery. Hereinafter, a lithium sulfur battery will be described.

The lithium sulfur battery may include a negative electrode and a positive electrode, and the negative electrode may be a lithium electrode while the positive electrode may be a sulfur electrode. In other words, the positive electrode may be a sulfur electrode containing at least sulfur. In this case, the sulfur electrode of the present disclosure is preferably configured as a positive electrode of sulfur (S) such as S₈ or polymeric sulfur. Since the negative electrode is a lithium electrode, the secondary battery of the present disclosure includes a pair of lithium electrode-sulfur electrode.

The term “sulfur electrode” as used herein refers to an electrode containing sulfur (S) as an active ingredient (namely, an active material) in a broad sense. The term “sulfur electrode” refers to an electrode that contains at least sulfur in a narrow sense, for example, refers to an electrode containing sulfur (S) such as S; and/or polymeric sulfur, particularly a positive electrode containing sulfur (S) such as S; and/or polymeric sulfur. The sulfur electrode may contain components other than sulfur, and may contain, for example, a conductive auxiliary agent and a binder. Although it is merely an example, the sulfur content in the sulfur electrode may be 5% by mass to 95% by mass, for example, about 50% by mass to 90% by mass based on the whole electrode.

As described above, in the secondary battery including the electrode using the carbon material according to the present embodiment as the positive electrode, the carbon material 1 includes the fibrous carbon 11, the covering material 20 covering the fibrous carbon 11, and the exposed portion 12 in which a part of the fibrous carbon 11 is exposed from the covering material 20. According to the secondary battery including the electrode using the carbon material as the positive electrode, since the exposed portion 12 in which a part of the fibrous carbon 11 is exposed from the covering material 20 is provided, the exposed portion 12 can be bent to reduce the number of voids in the electrode, and the energy density of the battery can be improved.

### —Method of Producing Carbon Material—

Next, the “method of producing a carbon material” according to the embodiment of the present disclosure will be described. The method of producing a carbon material of the present disclosure includes a covering step and an exposing step. Hereinafter, the production process will be described.

### <Covering Step>

The covering step is a step of covering fibrous carbon with a covering material. Specific process contents will be described in detail below.

First, fibrous carbon is provided. As an example of the fibrous carbon, a single-wall carbon nanotube (SWCNT) is used; however, a multi-wall carbon nanotube (MWCNT) such as a double-wall carbon nanotube (DWCNT) or the like, or a carbon nanofiber may be used. After the fibrous carbon is provided, the fibrous carbon is dispersed with a dispersant (as an example, carboxymethylcellulose), and a raw material liquid as a raw material of the covering material is mixed therewith.

The raw material liquid as the raw material of the covering material is preferably a solution containing a saccharide. More preferably, such a raw material that produces furfural from a saccharide through an isomerization and/or dehydration reaction is preferable, and for example, at least one selected from the group consisting of xylose, glucose, sucrose, fructose and maltose may be contained.

The raw material liquid containing the mixed fibrous carbon is subjected to a hydrothermal treatment to produce fibrous carbon covered with a covering material precursor. As an example of the hydrothermal treatment method, a treatment condition of 180 to 240° C. for 1 to 20 hours or less using a pressure vessel of an autoclave can be cited. By performing the hydrothermal treatment under the above treatment conditions, furfural suitably produced through the isomerization and/or dehydration reaction can be polymerized to produce fibrous carbon covered with the covering material precursor.

After the hydrothermal treatment, filtration washing is performed, and the fibrous carbon covered with the covering material precursor is pulverized and recovered. Thereafter, this is dried to obtain a carbon powder. Zinc chloride is mixed with the carbon powder and subjected to heat treatment, whereby the covering material precursor reacts with zinc chloride and is activated to obtain a carbon material in which the surface of fibrous carbon is covered with the covering material. That is, in order to make many pores, it is preferable to mix zinc chloride or the like and perform heat treatment. More specifically, the covering material precursor is activated to form activated carbon, and the activated carbon is made porous. As an example of the heat treatment, heat treatment conditions of a temperature of 750 to 1500° C. in a nitrogen atmosphere for 30 minutes to 2 hours can be mentioned. In addition, the temperature is preferably 750 to 1000° C.

### <Exposing Step>

The exposing step is a step of exposing a part of the fibrous carbon from the covering material. As a suitable exposing step, an external force may be applied to the covering material. The phrase “applying an external force to the covering material” as used herein means that a force to such an extent that the covering material is removed is applied, and specifically includes application of a shear stress caused by generation of a turbulent flow by ultrasonic irradiation or the like to the covering material in addition to application of a physical stress to the covering material. Specific process contents will be described in detail below by exemplifying an external force applying mode using ultrasonic irradiation.

After the covering step described above, in order to remove residues such as zinc chloride used for activating the covering material precursor or zinc oxide caused by zinc chloride, the carbon material in which the surface of the fibrous carbon is covered with the covering material is added to an aqueous hydrochloric acid solution, and ultrasonic irradiation is performed. As an example of the ultrasonic irradiation conditions, conditions of an ultrasonic frequency of 30 to 40 kHz, an output of 150 to 250 W, and a treatment time of 30 minutes to 2 hours are exemplified. Thereafter, ultrasonic irradiation in ethanol and ultrasonic irradiation in pure water may be additionally performed. The conditions of the ultrasonic irradiation may be the same condition or different conditions.

In the exposing step described above, an external force applying mode using ultrasonic irradiation has been described; however, instead of this, the external force may be applied to the covering material by, for example, a pulverizer (ball mill).

Through the above steps, it is possible to produce the carbon material including the exposed portion in which a part of the fibrous carbon is exposed from the covering material, which has been described in “-Embodiment of carbon material-”. When the produced carbon material contains 0.5% by weight to 5% by weight of fibrous carbon as a whole, the carbon material is suitable as characteristics of the secondary battery.

### —Additional Steps of Method of Producing Carbon Material—

The method of producing a carbon material in which the covering material is a support that supports the electrode active material described in “-Other embodiments of carbon material-” includes a “supporting step” in addition to the “covering step” and the “exposing step” described above. Hereinafter, the supporting step will be described.

### <Supporting Step>

The supporting step is a step of supporting the electrode active material on the covering material after the covering step. Specifically, the electrode active material is mixed with the carbon material subjected to the covering step, and heated at 100 to 200° C. for 30 minutes to 2 hours to fill the covering material with the electrode active material. Examples of the electrode active material include sulfur powder, and the sulfur powder is encapsulated in pores of porous activated carbon as the covering material.

The content of the electrode active material to be mixed is preferably 50% by weight to 65% by weight based on the entire carbon material. By setting the content of the electrode active material, suitable characteristics of the secondary battery can be obtained.

### EXAMPLES

Examples related to the present disclosure will be described.

A demonstration test was performed on the carbon materials of Examples 1 to 3 and Comparative Examples 1 to 3 shown in Tables 1 and 2 below. The carbon material of Examples 1 to 3 was subjected to the covering step, the exposing step, and the supporting step in the method of producing a carbon material described above. On the other hand, the carbon material of Comparative Examples 1 to 3 was subjected to the covering step and the supporting step (that is, the exposing step was not performed). The content in the table indicates a ratio based on the entire carbon material. The “average thickness” in the table indicates a thickness measured from the SEM image described later.

TABLE 1

| | Example 1 | Example 2 | Example 3 |
|---|---|---|---|
| Fiber material | SWCNT Content: 1 wt % | SWCNT Content: 0.7 wt % | SWCNT Content: 3 wt % |
| Covering material | Raw material liquid: aqueous | Raw material liquid: aqueous | Raw material liquid: aqueous |
| | xylose solution | xylose solution | xylose solution |
| Electrode active material | Sulfur Content: 60 wt % | Sulfur Content: 60 wt % | Sulfur Content: 60 wt % |
| Formation of exposed portion | Formed | Formed | Formed |
| Average thickness of carbon material | 200 nm | 250 nm | 90 nm |
| excluding exposed portion | | | |

TABLE 2

| | Comparative Example 1 | Comparative Example 2 | Comparative Example 3 |
|---|---|---|---|
| Fiber material | SWCNT Content: 1 wt % | SWCNT Content: 0.7 wt % | SWCNT Content: 3 wt % |
| Covering material | Raw material liquid: aqueous | Raw material liquid: aqueous | Raw material liquid: aqueous |
| | xylose solution | xylose solution | xylose solution |
| Electrode active material | Sulfur Content: 60 wt % | Sulfur Content: 60 wt % | Sulfur Content: 60 wt % |
| Formation of exposed portion | Not formed | Not formed | Not formed |
| Average thickness of carbon material | 200 nm | 250 nm | 90 nm |

### <Evaluation by SEM Photograph>

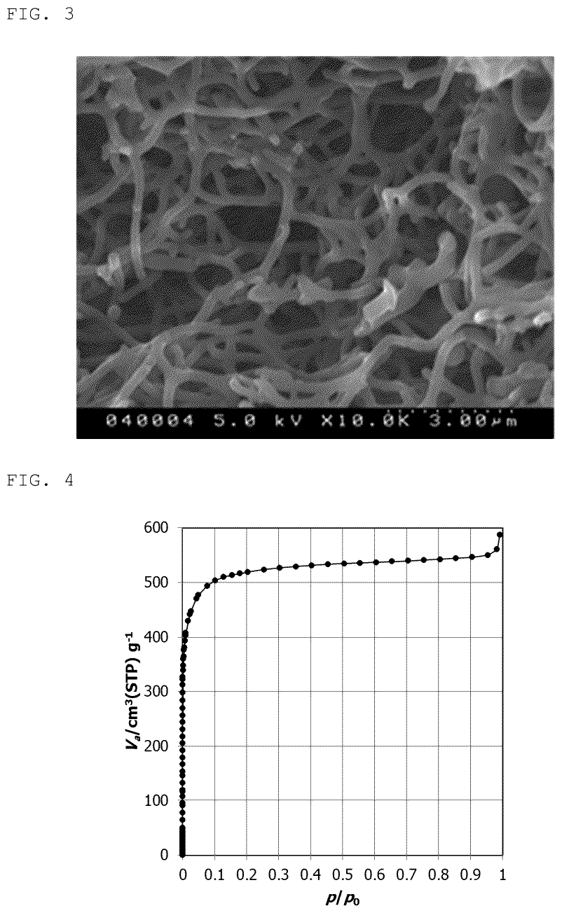

The above-described Example 1 and Comparative Example 1 were evaluated by SEM photographs. FIGS. 2 to 3 show an imaged SEM photograph.

FIG. 2A is an SEM photograph obtained by irradiating the carbon material of Example 1 with an electron beam at an acceleration voltage of 5 kV and imaging the carbon material at an observation magnification of 50,000 times. According to FIG. 2A, it can be grasped that the carbon material has the exposed portion 12 in which a part of the fibrous carbon is exposed from the covering material 20. On the other hand, in the carbon material of Comparative Example 1, fibrous carbon was totally covered with the covering material (see, for example, FIG. 3).

Next, the carbon materials of Example 1 and Comparative Example 1 were irradiated with an electron beam at an acceleration voltage of 5 kV, and SEM photographs were imaged at an observation magnification of 10,000 times. FIG. 2B is an SEM photograph of the carbon material of Example 1, and FIG. 3 is an SEM photograph of the carbon material of Comparative Example 1. That is, FIGS. 2B and 3 are SEM photographs imaged under the same observation condition. Comparing FIG. 2B with FIG. 3, the carbon material of Example 1 was formed relatively densely, whereas voids were scattered in the carbon material of Comparative Example 1.

### <Evaluation of Capacitance Density>

Next, an electrode was produced using the carbon materials of Examples 1 to 3 and Comparative Examples 1 to 3, and the capacitance density of the electrode was evaluated. As a secondary battery for evaluating an electrode, a 2032 size coin cell was manufactured. Here, a sulfur electrode using the above-described carbon material was used as the positive electrode, Li metal was used as the negative electrode, Celgard 3501 was used as the separator, and lithium bis (trifluoromethanesulfonyl) imide (LiTFSI) having a concentration of 1 M dissolved in a mixed solvent of fluoroethylene carbonate (FEC) and vinylene carbonate (VC) (volume ratio: 1:1) was used as the electrolytic solution.

In the evaluation of the capacitance density (mAh/cc), a discharge capacitance density was evaluated by calculating a product of an electrode density (g/cc) and a discharge capacitance (mAh/g). The electrode density (g/cc) was calculated from the weight and volume of the electrode, and the discharge capacitance (mAh/g) was taken as the discharge capacitance (3rd discharge capacitance) after 3 cycles at 0.05 C. The evaluation results are shown in Table 3 below.

TABLE 3

| | Example | Example | Example | Comparative | Comparative | Comparative |
|---|---|---|---|---|---|---|
| | 1 | 2 | 3 | Example 1 | Example 2 | Example 3 |
| Electrode | 0.4 | 0.43 | 0.3 | 0.25 | 0.31 | 0.24 |
| density | | | | | | |
| (g/cc) | | | | | | |
| 3rd | 1130 | 1057 | 1405 | 1155 | 1048 | 1425 |
| discharge | | | | | | |
| capacitance | | | | | | |
| (mAh/g) | | | | | | |
| Capacitance | 452 | 455 | 422 | 289 | 325 | 342 |
| density | | | | | | |
| (mAh/cc) | | | | | | |
| Evaluation | ◯ | ◯ | ◯ | X | X | X |

From the results in Table 3, the capacitance density of Examples 1 to 3 was higher than the capacitance density of Comparative Examples 1 to 3. According to the results, in the carbon material including the exposed portion in which a part of the fibrous carbon was exposed from the covering material, a result due to improvement in capacitance density was obtained. That is, it is possible to obtain an electrode having a high capacitance density by using the result, and it is possible to improve the energy density of the secondary battery by using this electrode.

### <Evaluation of Covering Material>

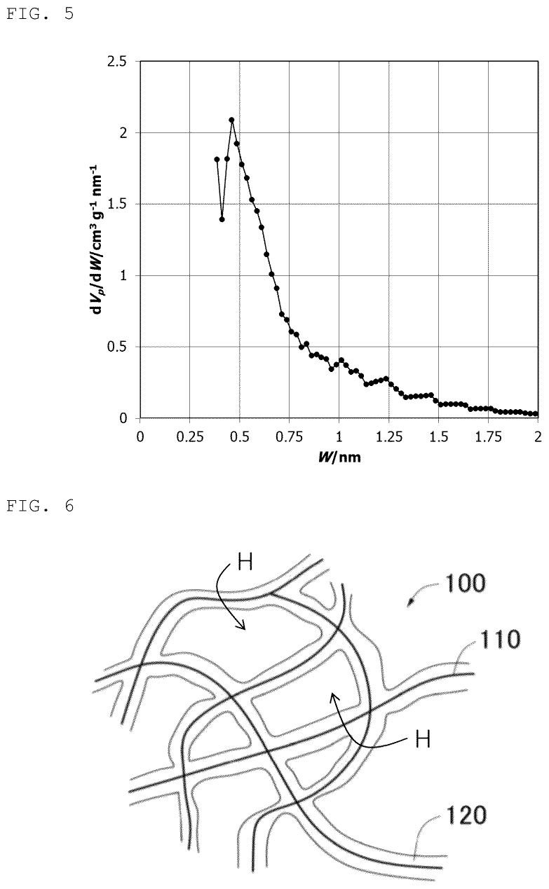

Next, the carbon materials of Examples 1 to 3 were evaluated for activation in the covering step. Specifically, the activated carbon obtained by activating the covering material precursor was evaluated. The activated carbon was evaluated based on the adsorption/desorption isotherm (FIG. 4) and pore distribution (FIG. 5).

In the adsorption/desorption isotherm shown in FIG. 4, the horizontal axis corresponds to a relative pressure, and the vertical axis corresponds to an N₂ adsorption amount. According to a waveform of the obtained isotherm, the waveform corresponded to the waveform of type I of IUPAC classification, and the result that micropores (pores) of 2 nm or less existed was obtained. That is, a result was obtained in which a large number of pores of 2 nm or less were formed in the activated carbon obtained by activating the covering material precursor.

The pore distribution shown in FIG. 5 is a distribution obtained by analyzing the adsorption/desorption isotherm of FIG. 4 by an HK method, and the horizontal axis corresponds to a pore diameter and the vertical axis corresponds to a distribution ratio. According to the pore distribution in FIG. 5, a distribution in which a peak was obtained in the vicinity of a diameter of 0.4 to 0.5 nm on the horizontal axis was obtained, and a result was obtained in which the activated carbon had many pores formed in the vicinity of a diameter of 0.4 to 0.5 nm.

According to the evaluation results of FIGS. 4 and 5, it has been confirmed that activated carbon containing pores is suitably formed by activation in the covering step of the present disclosure. In addition, the activation is an additional element of the carbon material of the present disclosure, and the feature of the carbon material of the present disclosure is that the exposed portion is formed as described above.

It is to be noted that embodiments disclosed herein are considered by way of illustration in all respects, and not considered as a basis for restrictive interpretations. Accordingly, the technical scope of the present disclosure is not to be construed only by the embodiments mentioned above, but is defined based on the description of the claims. In addition, the technical scope of the present disclosure encompasses meanings equivalent to the claims and all modifications within the scope of the claims.

The electrode and the secondary battery according to the present disclosure can be used in various fields in which battery use or power storage is assumed. By way of example only, the present disclosure can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home power storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

1: Carbon material
11: Fibrous carbon
12: Exposed portion
20: Covering material

1. A carbon material comprising:
fibrous carbon; and
a covering material that covers portions of the fibrous carbon such that the fibrous carbon has an exposed portion in which a part of the fibrous carbon is exposed from the covering material.

2. The carbon material according to claim 1, wherein the covering material is present on opposed sides of the exposed portion.

3. The carbon material according to claim 1, wherein a part of the exposed portion is bent.

4. The carbon material according to claim 1, wherein the fibrous carbon is a carbon nanotube or a carbon nanofiber.

5. The carbon material according to claim 1, wherein the covering material is porous.

6. The carbon material according to claim 1, wherein the covering material is a material containing carbon.

7. The carbon material according to claim 6, wherein the carbon is activated carbon.

8. The carbon material according to claim 1, wherein the covering material is constructed as a support that supports an electrode active material.

9. The carbon material according to claim 8, wherein the electrode active material contains sulfur.

10. An electrode comprising the carbon material according to claim 1.

11. A secondary battery comprising the electrode according to claim 10 as a positive electrode.

12. A secondary battery comprising the electrode according to claim 10 as a negative electrode.

13. A method of producing a carbon material, the method comprising:
covering fibrous carbon with a covering material; and
exposing a part of the fibrous carbon from the covering material.

14. The method of producing a carbon material according to claim 13, wherein the covering of the fibrous carbon includes mixing a solution containing a saccharide with the fibrous carbon.

15. The method of producing a carbon material according to claim 14, wherein the saccharide is a material that generates furfural.

16. The method of producing a carbon material according to claim 14, wherein the saccharide includes at least one selected from the group consisting of xylose, glucose, sucrose, fructose and maltose.

17. The method of producing a carbon material according to claim 13, wherein the covering of the fibrous carbon includes activating the covering material to form activated carbon.

18. The method of producing a carbon material according to claim 17, further comprising supporting an electrode active material on the covering material after the activating of the covering material.

19. The method of producing a carbon material according to claim 13, wherein the exposing of the part of the fibrous carbon from the covering material includes applying an external force to the covering material.

20. The method of producing a carbon material according to claim 19, wherein the external force is applied by ultrasonic irradiation or a pulverizer.
